(19) United States
(12) Patent Application Publication
(10) Pub. No.: US 2026/0246992 A1
(43) Pub. Date: Aug. 20, 2026

(54) Synchronization in Cloud-Based User Interface (UI) Streaming

(71) Applicant: Synamedia Limited, Maidenhead (GB)

(72) Inventors: Amotz Terem, Jerusalem (IL); Thomas Paul Burnley, Hampshire (GB); Zorach Reuven Wachtfogel, Elazar (IL); Michael Howard Miller, Bet Shemesh (IL); Daren Paul Hayward, Hampshire (GB); Mordechai Regev, Lod (IL)

(21) Appl. No.: 19/057,934

(22) Filed: Feb. 19, 2025

(51) Int. Cl. H04N 21/43; H04N 21/858

(52) U.S. Cl. CPC H04N 21/4307; H04N 21/8586

(57) ABSTRACT

Techniques for video and audio synchronization in cloud-based UI streaming are described herein. In various embodiments, server(s) hosting a cloud computing platform streaming a UI video with an embedded video to a client device via a first channel, where the embedded video has a corresponding audio track delivered to the client device via a second channel, different from the first channel. The server(s) also receive a synchronization message indicating synchronization status between a video presentation timestamp from the embedded video obtained at the client device and an audio presentation timestamp from the corresponding audio track obtained by client device. The server(s) then instructs video playback of the embedded video at a speed determined based on the synchronization status and render the UI video with the embedded video, including attaching the video presentation timestamps from the video playback of the embedded video to video frames of the UI video.

### TECHNICAL FIELD

The present disclosure relates generally to multimedia content delivery and, more specifically, to synchronizing audio and video in cloud-based user interface (UI) streaming.

### BACKGROUND

In cloud-based user interfaces (UI) transmission via low latency protocols, such as Web Real-Time Communications (WebRTC), it is challenging to synchronize embedded video and audio in such UIs, e.g., synchronizing an adaptive bitrate (ABR) video embedded in the cloud-rendered UI and the audio playback for the embedded ABR video. In recent years, WebRTC has become a preferred technology for real-time streaming of UIs from cloud servers to client devices due to its low-latency properties and robust support for video and audio communication. This approach works well for transmitting real-time visuals, such as navigation menus, dashboards, or interactive elements. However, a common scenario arises when ABR video is embedded within the UI, such as a video preview or a small media player component, where the associated audio is played for the embedded video. The native solution to this problem involves capturing the video and audio from the UI engine in the cloud and sending them together via WebRTC to ensure synchronization. This approach presents several significant challenges. One major issue is the lack of buffering in WebRTC's real-time streaming protocol, which can lead to robustness issues, such as dropped frames or desynchronized playback. Another issue is the requirement to transcode the audio to meet WebRTC's codec standards. This additional transcoding step introduces processing overhead and potential quality degradation, particularly in cases where the original audio is already encoded using an ABR format.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram illustrating an exemplary cloud-based UI streaming system with video and audio synchronization, in accordance with some embodiments;

FIG. 2 is a diagram illustrating synchronizing audio and video of an exemplary cloud-rendered UI frame with an embedded video, in accordance with some embodiments;

FIG. 3 is a diagram illustrating rate adjustments for video and audio synchronization, in accordance with some embodiments;

FIG. 4 is a diagram illustrating seamless transitions from UI stream to full screen ABR playback, in accordance with some embodiments; and

FIG. 5 is a flowchart illustrating a video and audio synchronization method in cloud-based UI streaming, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overview

Methods, devices, and systems described herein overcome the aforementioned cloud-based user interface (UI) limitations by streaming audio of an adaptive bitrate (ABR) video directly to the client through an HTTP ABR stream, separate and distinct from a Web Real-Time Communications (WebRTC) video stream. A feedback mechanism between the cloud and the client ensures the audio remains synchronized with real-time video playback without requiring transcoding or creating robustness issues. Additionally, the solution facilitates seamless transitions from a WebRTC-based UI to full-screen ABR playback. During the transition, the audio playback continues uninterrupted on the same ABR stream, while the video feed switches smoothly from the WebRTC UI to full-screen ABR. Such design eliminates audio disruptions during transitions and enhances the overall user experience. The methods, devices, and systems described herein thus improve the reliability, efficiency, and seamless integration of audio synchronization for embedded videos in cloud-based UIs, addressing key challenges in current real-time UI streaming architectures.

In accordance with various embodiments, a synchronization method for cloud-based UI streaming is performed at one or more servers including one or more processors and non-transitory memory. The method includes streaming a user interface (UI) video to a client device via a first channel, wherein the UI video includes an embedded video, and the embedded video has a corresponding audio track delivered to the client device via a second channel, different from the first channel. The method also includes receiving a synchronization message indicating synchronization status between a video presentation timestamp from the embedded video obtained at the client device and an audio presentation timestamp from the corresponding audio track obtained by client device. The method additionally includes instructing video playback of the embedded video at a speed determined based on the synchronization status extracted from the synchronization message. The method further includes rendering the UI video with the embedded video for streaming to the client device via the first channel, including attaching the video presentation timestamps from the video playback of the embedded video to video frames of the UI video.

### Example Embodiments

Cloud-based user interface (UI) streaming methods, devices, and systems described herein leverage a synchronization controller in the cloud and a presentation timestamp (PTS) reporter on the client side to create a feedback mechanism. The feedback mechanism synchronizes videos embedded in cloud-rendered UIs with their corresponding audio. In some embodiments, the synchronization controller receives synchronization status reports from the PTS reporter and adjusts the playback rates of embedded video during UI rendering. In some embodiments, the synchronization controller attaches presentation timestamp(s) to corresponding UI video frames, enabling identification and comparison of corresponding audio unit PTS values for each frame with an embedded adaptive bitrate (ABR) video. To maintain synchronization, the cloud adjusts video playback to address discrepancies between audio and video PTS values. In some embodiments, the adjustment involves slightly speeding up or slowing down the playback of the embedded video until the PTS difference approaches zero. Once audio and video are synchronized (i.e., the PTS difference is close to zero or below a threshold), the cloud restores the video playback rate to normal (e.g., rate=1) in accordance with some embodiments. The continuous feedback loop ensures audio and video of the embedded video in cloud-rendered UI remain synchronized, thus providing a seamless user experience.

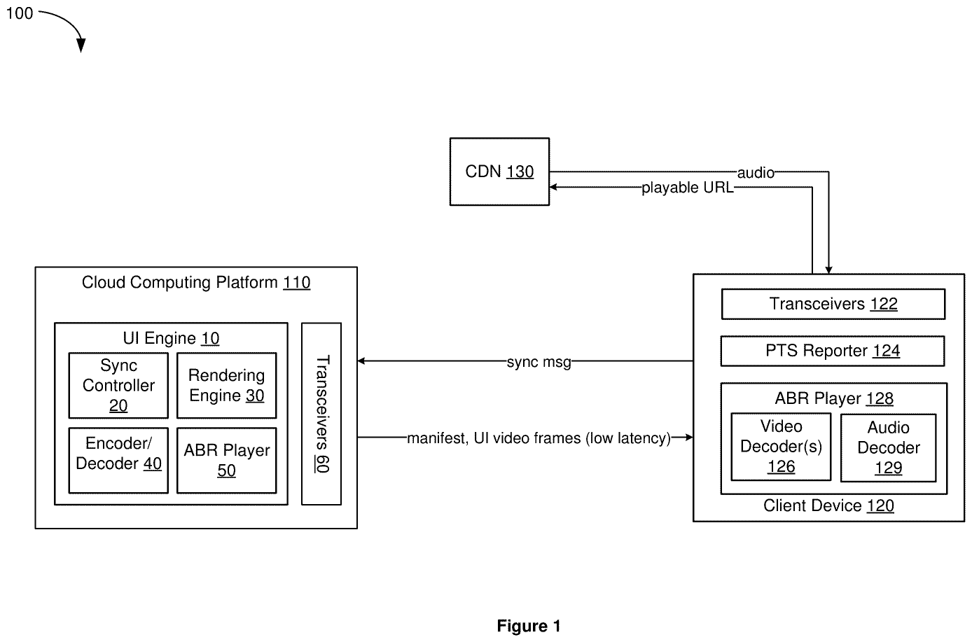

Reference is now made to FIG. 1, which is a block diagram of an exemplary multimedia content delivery system 100 that enables audio and video synchronization in cloud-based UI streaming in accordance with some embodiments. The multimedia content (also referred to hereinafter as “media content”, “media content item(s)”, “media asset”, or “content”) can include any multimedia data, such as visual data, audio data, and/or text, etc. In some embodiments, the content delivery system 100 includes a cloud computing platform 110, one or more client devices, e.g., including an exemplary client device 120, and a content delivery network (CDN) 130.

In some embodiments, the client device 120 is a set-top-box (STB) connected to or coupled with a television (TV) or any computing device that is capable of decoding and playing videos outputted to a respective display. It should be noted that, a respective client device 120 can be separate and distinct from a respective display or combined with a respective display, e.g., a smart TV and/or a computing device with a display. The exemplary client device 120 includes one or more video decoders 126 for decoding video frames, including low latency UI videos and/or buffered ABR videos. The exemplary client device 120 also includes an audio decoder 129 for decoding audio data.

In some embodiments, the client device 120 is a thin client, which has limited resources to render graphics, e.g., without a graphic processing unit (GPU) for rendering. For optimal performance, the cloud computing platform 110 includes a UI engine 10 to prepare graphics for the client device 120. For example, in the exemplary cloud computing platform 110, the UI engine 10 includes a rendering engine 30 for rendering cloud television (TV) UIs, one or more encoders 40 for encoding the TV UIs, and an ABR player 50 for playing out ABR videos to be embedded in the TV UIs. In some embodiments, the encoder(s) 40 also include one or more decoders and/or re-encoders to facilitate the encoding of videos in preparation for content delivery to the client device 120. For example, as will be described in further detail below, the encoder(s) 40 includes a low latency encoder (or re-encoder) to encode the UI into a low latency stream.

Real-time content delivery protocols, such as Web Real-Time Communication (WebRTC) and/or Real-Time Protocol (RTP), are often used for low latency content delivery to thin clients for fast response time. As used herein, low latency TV UI videos are also known as “low latency UI videos”, “low latency content”, “UI videos”, “application video streams”, or “application videos”. As used herein, adaptive bitrate (ABR) videos are also known as “buffered content” or “buffered videos”. For low latency content, the depth of the client buffer filled with the UI video frames is less than a threshold, e.g., 250 ms of UI video frames. As such, the low latency content fills the client buffer with a short buffer of content for providing immediate UI responses, e.g., real-time responses.

Unlike streaming protocols for real-time content, which require delivery in the magnitude of milliseconds to ensure an uninterrupted user experience, buffered content prioritizes reliability over speed and typically operates with a latency in the magnitude of seconds. ABR videos typically require a deep client buffer to allow for retries. When the client bandwidth temporarily drops, the buffered content can be re-transmitted to re-fill the large buffer. As a result, the client device 120 can recover from potential packet loss to reduce visible glitches for uninterrupted client experience. Due to the difference in buffering requirement, the low latency content prepared by the UI engine 10 is typically transmitted to the client device 120 via a different channel and/or using a different protocol from the delivery of ABR content.

For example, the cloud computing platform 110 can include one set of transceivers 60 (e.g., one or more network interfaces) for establishing one or more channels for low latency content communication with the client device 120 and a different set of transceivers 60 for establishing one or more channels for buffered content communication. Likewise, the client device 120 can include one set of transceivers 122 for establishing one or more channels for low latency content communication with the cloud computing platform 110, e.g., for UI video frames, sending commands and/or user inputs, and/or signaling, and a different set of transceivers 122 for establishing one or more channels for buffered content communication with the CDN 130, e.g., for ABR video and/or audio data.

Using the UI engine 10, the cloud computing platform 110 renders TV UIs and delivers the rendered and encoded UI videos to the thin client device 120. On the client side, the client device 120 includes one or more video decoders 126 configured to decode the server-prepared UI video frames for display. Though not shown in FIG. 1, the client device 120 includes one or more buffers for storing decoded content in preparation for playout. In some embodiments, the client device 120 configures one of the buffers for storing the low latency content and another one for storing the buffered content. As such, different buffers can be configured for different types of content and configured with different depth. For example, upon determining that the received content is low latency content, the client device 120 configures a buffer depth less than a first threshold or zero for a respective buffer to store the low latency content. In another example, upon determining that the received content is buffered content, the client device 120 configures a buffer depth greater than a second threshold for a respective buffer to store the buffered content.

In some embodiments, when the UI engine 10 prepares the UI video frames, an ABR video is embedded in the UI frames, e.g., a video preview in a catalog TV UI. In some embodiments, the UI engine 10 obtains the ABR video for embedding, e.g., from the CDN 130 or another media source, and re-encodes the ABR video to fit in the UI frames for low latency content delivery, e.g., re-encoding according to a different frame rate and/or resolution. Further, in some embodiments, the UI engine 10 packages the UI video frames and provides a manifest referencing the audio corresponding to the embedded ABR video.

In some embodiments, the client device 120 includes an ABR player 128 that requests the audio from the CDN 130 by sending to the CDN 130 via one of the transceivers 122 a playable URL referencing the audio file corresponding to the embedded video in the cloud-rendered UI. As used herein, the playable URL can be a link or content identifier to media resources such as segment, a URL of a manifest, where the manifest includes links to the media resources such as segments, or any link or content identifier from which the client device 120 can acquire the manifest, the link, or the content identifier.

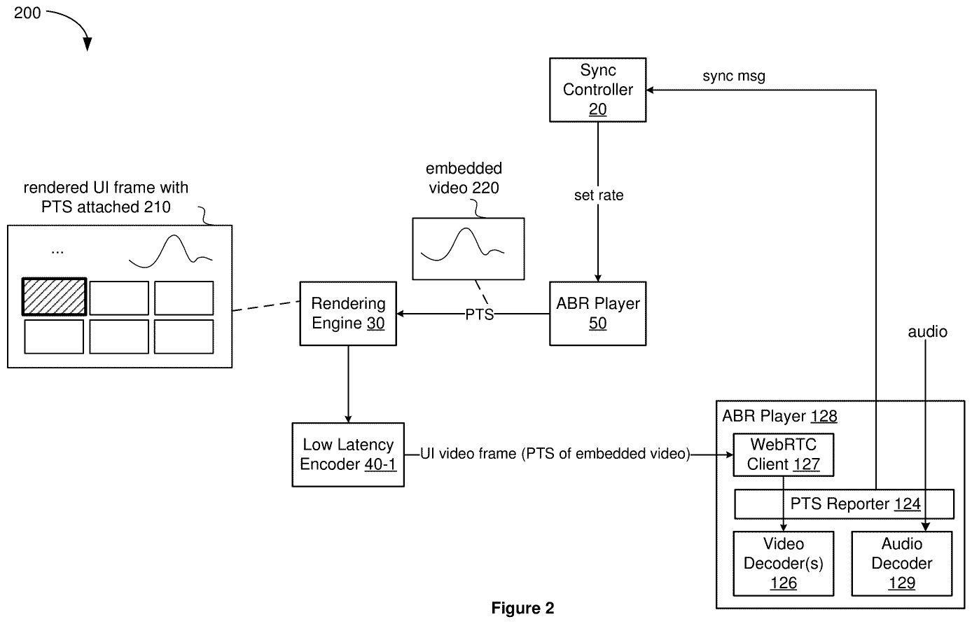

In response to receiving the playable URL from the client device 120, in some embodiments, the CDN 130 sends the audio data corresponding to the embedded ABR video to the client device 120. In some embodiments, as will be described in further detail below with reference to FIG. 2, upon obtaining the audio data, the ABR player 128 forwards the audio data to an audio decoder 129 of the client device 120 for decoding and playout and sends the audio presentation timestamp (PTS) to a PTS reporter 124 for synchronization reporting. In some embodiments, the PTS reporter 124 also obtains the video PTS of the embedded video frames received from the cloud computing platform 110. Further, in some embodiments, the PTS reporter 124 generates one or more synchronization messages indicating the video PTS in relation to the audio PTS and sends the synchronization message(s) via low latency content delivery protocol, such as Real-time Transport Control Protocol (RTCP) to the cloud computing platform 110.

In some embodiments, to synchronize the audio and the embedded video in the server-prepared UI, the UI engine 10 includes a synchronization controller 20 that processes the synchronization message(s) from the PTS reporter 124 and utilizes a feedback mechanism to ensure synchronization. Upon receiving the synchronization message(s), the UI engine 10 adjusts the video speed of the ABR player 50 to correct any discrepancies between the audio and video PTS values. The adjustment continues until the difference between the two PTS values approaches zero. The continuous feedback loop ensures that the video and audio associated with the server-prepared UI remain in sync, thus providing a smooth user experience.

It should be noted that although a single UI engine 10 is illustrated in FIG. 1, the system 100 may include one or more instances of the UI engine 10, e.g., multiple servers hosting virtual machines running on top of CPU(s) and/or GPU(s) supporting pool(s) of UI engines 10 for UI rendering. For the sake of simplicity, the subject matter will be described hereinafter for the most part with reference to a single UI engine 30. Further, one or more components and/or functions of the components illustrated in FIG. 1 may be distributed and/or re-arranged. For example, the encoder/decoder 40 and/or the ABR player 50 can be parts of the UI engine 10 or as separate components coupled with the UI engine 10. In another example, the video decoder(s) 126 can be part of the ABR player 128 or separate from the ABR player 128. As such, the server side and/or the client side of the content delivery system 100 can include more, less, and/or different elements than shown in FIG. 1. Each of the component in the content delivery system 100 can include appropriate hardware, software, and/or firmware to perform the operations attributed to the element herein. Operation(s) attributed to an element in the content delivery system 100 herein should not be considered binding and in some embodiments, other element(s) in the exemplary system 100 may additionally or alternatively perform such operation(s).

FIG. 2 is a diagram 200 illustrating synchronizing audio and video of an exemplary cloud-rendered UI frame with an embedded ABR video in the exemplary multimedia content delivery system 100 in accordance with some embodiments. In some embodiments, the UI engine 10 (FIG. 1) receives an input from the client device 120 (FIG. 1) requesting a TV UI, e.g., via a low latency transport mechanism such as WebRTC. Such user inputs include pressing a button, voice inputs to a voice recorder, and/or user inputs detected by a sensor, etc. In some embodiments, the requested UI includes UI elements and one or more embedded videos. For example, in FIG. 2, an exemplary UI 210 requested by the client is a catalog selection screen with a plurality of tiles; and when the user highlights a tile, a corresponding video preview 220 (or a corresponding small media player component) is displayed as an embedded video.

In some embodiments, the rendering engine 30 renders the UI 210 in response to the request for the UI, e.g., by executing one or more applications for UI rendering. An application as used herein refers to an executable program, or a listing of instructions for execution, that defines and outputs a UI for display on a display device. Though not shown in the figures, in some embodiments, for improved efficiency, the rendering engine 30 caches rendered UI objects and utilizes the cached rendered UI objects for compositing UI elements, e.g., caching each tile in a catalog, etc. When rendering the UI 210, the rendering engine 30 obtains the embedded video 220 from the ABR player 50 and positions the embedded video 220 at a predefined location according to predefined display properties associated with the UI 210 and the embedded video 220.

In some embodiments, to compose the server-rendered UI frame with the embedded ABR video, the UI engine instructs the ABR player 50 to obtain the ABR video and emulate the play of the ABR video to provide frames from the ABR video to the rendering engine 30. In some embodiments, the ABR player 50 on the server side is similar to the ABR player 128 on the client side in that the ABR player 50 requests and obtains a manifest for the embedded ABR video, e.g., from the CDN 130 (FIG. 1) or a media content source, where the manifest describes the available stream segments and their respective bitrates of the embedded ABR video. Also similar to the ABR player 128 on the client side, the server side ABR player 50 includes a decoder and can play the ABR video at different speed, e.g., choosing which frames to decode for the playback. In some embodiments, the ABR player 50 on the server side receives the rate setting instructions from the synchronization controller 20, e.g., normal speed when rate=1 or lower speed when rate=0.5, etc. According to the rate setting instructions, the ABR player 50 plays the embedded video 220 faster or slower to be in sync with the audio units corresponding to the embedded video 220.

In some embodiments, the synchronization controller 20 receives synchronization messages from the PTS reporter 124 on the client side, e.g., via RTCP messages transmitted through one of the transceivers 122 (FIG. 1). In some embodiments, the synchronization messages indicate the difference between the video PTS and the corresponding audio PTS as received on the client side. For example, the PTS reporter 120 can include in the synchronization messages the video PTS and the audio PTS values, and the synchronization controller 20 can calculate the difference in order to determine whether the video and the audio are in sync. In another example, the PTS reporter 124 calculates the difference between the video and audio PTS values and reports the difference in the synchronization messages.

In some embodiments, the synchronization controller 20 sets the rate for the ABR player 50 based on the synchronization messages. In the case of the synchronization messages indicating that the audio and UI video are out of sync, the synchronization controller 20 instructs the ABR player 50 to gradually adjusts the playback rate of the embedded video 220 on the server side. The rendering engine 30 then composites the embedded video 220 played by the ABR player 50 with UI elements to generate the rendering UI frame 210 and attaches the video PTS (and optionally the audio PTS) of the embedded ABR video to the UI frame 210. One of the encoders 40 (FIG. 1), e.g., a low latency encoder 40-1, then encodes the composited UI frame 210 for low latency content delivery to the client side. As such, from the encoder's perspective, the low latency encoder 40-1 encodes the UI video frames (including the embedded ABR video and with the PTS in the frame header attached as metadata) and passes them downstream to the client.

On the client side, there are two separate feeds. One is the UI video stream (with the embedded video), where each frame includes the embedded video's PTS, e.g., with the PTS attached in the frame header. The other is the ABR audio stream corresponding to the embedded video from the CDN 130 (FIG. 1), which includes audio PTS for each audio unit. In some embodiments, when playing UI videos, the ABR player 120 is configured to a low latency mode, where there is little or no buffering of the received content, e.g., the buffer depth for the video decoder(s) 126 and the audio decoder 129 is less than a threshold. In the low latency mode, in some embodiments, the ABR player 120 forwards both feeds to the respective decoders as soon as they arrive, e.g., forwarding the UI video frames received via a WebRTC client 127 to the video decoder(s) 126 and forwarding the audio units obtained from the CDN 130 (FIG. 1) to the audio decoder 129 without buffering the packets. However, before the video frames and audio units reach the decoders 126 and 129, the PTS reporter 124 obtains the video PTS of the embedded ABR video in UI video frames, e.g., by extracting the video PTS attached to the video frames from the frame header, and the audio PTS of the audio units, and generates synchronization messages based on the PTS to report the synchronization status to the synchronization controller 20.

In some embodiments, the PTS reporter 124 sends the synchronization message for each frame, e.g., sending a pair of the video and audio PTS or the difference upon receiving each UI frame. In some other embodiments, the PTS reporter 124 sends the synchronization message according to pre-defined policy, e.g., when the discrepancy between the video and audio PTS is greater than a threshold. The trade-off is between accuracy and traffic and/or cost. For example, higher frequency of sending the synchronization messages provides more accurate and faster synchronization. However, lower frequency of sending the synchronization messages translates to less traffic or lower cost.

It should be noted that the synchronization message can include more or less the information described herein for determining whether the video and audio for the embedded video are out of sync. Further, other representation for the determining difference can be used in place of or in conjunction with the method of comparing video PTS and audio PTS. For example, the current playable URL, a current session identifier, and/or an expected PTS value can be included in the metadata to facilitate the determination of the synchronization status. In another example, the video frame 220 obtained from the ABR player 50 for compositing the UI frame 210 has the video PTS value set and attached as metadata to the UI frame 210. This video PTS value may be different from the video PTS value of the UI frame. When these two PTS values match or are close to each other, the video would appear as though it came from the CDN 130 (FIG. 1). As such, by comparing the expected video PTS from the CDN 130 (FIG. 1) with the actual video PTS from the UI engine 10 (FIG. 1) and adjusting the playback speed of the embedded video on the server side, the video and audio of the embedded video would appear to be synchronized.

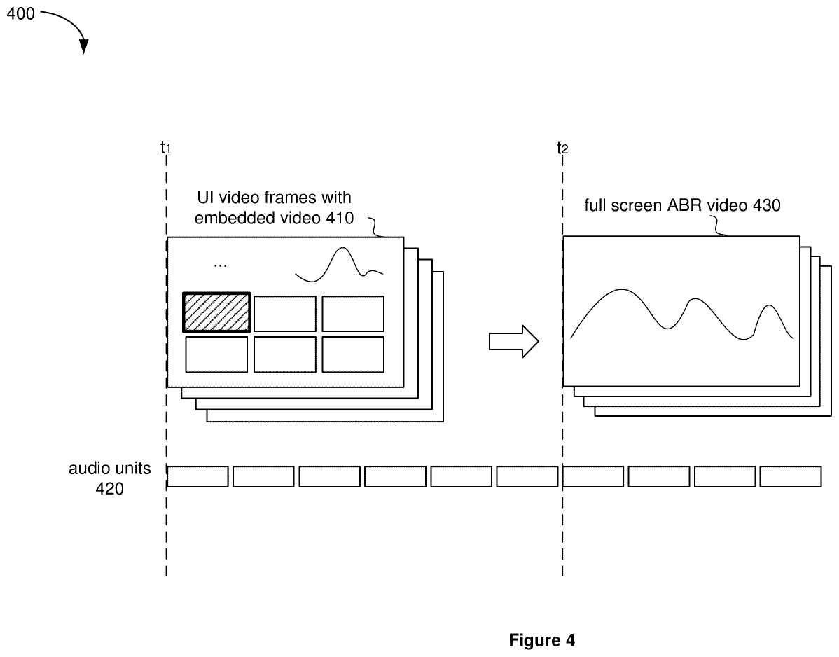

It should also be noted that the cloud can communicate information for composing the synchronization messages to the client side in-band (e.g., attached to the video frame headers as metadata) or out-of-band. Likewise, other signaling from the cloud to the client side can be in-band or out-of-band. For example, the manifest or the link to the media content or a stream switch as will be described below with reference to FIG. 4 can be signaled via a data channel (e.g., a data channel for WebRTC) out-of-band. Alternatively, the currently playable URL or a current session identifier of the currently playing asset can be packaged into the metadata and sent in-band along with the UI frames.

In some embodiments, once the difference between the audio and video PTS values is close to zero, the synchronization controller 20 sets the embedded video playback rate back to the normal rate, e.g., rate=1. Since both the server side ABR player 50 (for embedded video play) and the client side ABR player 128 (for corresponding audio play) then run at the same rate (e.g., rate=1), they are expected to stay relatively in sync, e.g., the difference between the video PTS and audio PTS values is within a threshold or close to zero. If they drift out of sync again, in some embodiments, the synchronization controller 20 detects the discrepancy via the continued PTS feedback loop and repeats the necessary adjustments. The continuous feedback loop ensures that the video and audio remain in sync, thus providing a smooth user experience.

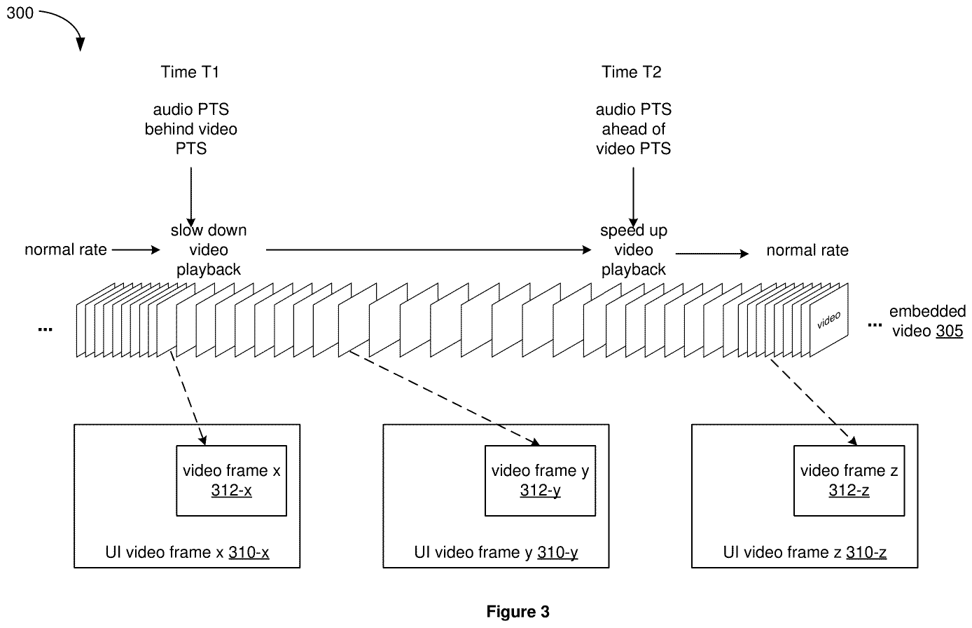

For example, FIG. 3 is a diagram 300 illustrating rate adjustments for video and audio synchronization of an embedded video 305 in a UI video. In the exemplary scenario shown in FIG. 3, initially the ABR player 50 (FIGS. 1 and 2) plays at a normal rate, e.g., rate=1. The rendering engine 30 (FIGS. 1 and 2) obtains video frames from the embedded video 305 for rendering a UI video, including obtaining video frame x 312-x and generating the composite UI video frame x 310-x with the embedded video frame x 312-x.

At time T1, in response to receiving a synchronization message indicating the PTS of the audio corresponding to the embedded video 305 is behind the video PTS of the video 305 embedded in the UI frame 310-x, the synchronization controller 20 (FIGS. 1 and 2) instructs the ABR player 50 (FIGS. 1 and 2) to slow down video playback of the embedded video 220 (FIG. 2), e.g., gradually adjusting the playback rate to 0.75. As a result of the slower speed, the ABR player 50 (FIGS. 1 and 2) chooses video frame y 312-y from the embedded video 305 to decode for the playback so that the rendering engine 30 (FIGS. 1 and 2) uses video frame y 312-y for compositing UI video frame y 310-y.

At time T2, in response to receiving another synchronization message indicating the PTS of the audio corresponding to the embedded video is ahead of the video PTS of the video 220 (FIG. 2) embedded in the UI frame 210 (FIG. 2), the synchronization controller 20 (FIGS. 1 and 2) instructs the ABR player 50 (FIGS. 1 and 2) to speed up video playback of the embedded video 220 (FIG. 2). As a result of the increased speed, the ABR player 50 (FIGS. 1 and 2) chooses video frame z 312-z from the embedded video 305 to decode for the playback so that the rendering engine 30 (FIGS. 1 and 2) uses video frame z 312-z for compositing UI video frame z 310-z, where when the intervals among UI video frames 310-x, 310-y, and 310-z are the same, the number of frames between video frames 312-x, 312-y, and 312-z are different.

FIG. 4 is a diagram 400 illustrating seamless transitions from UI stream to full screen ABR playback in accordance with some embodiments. As described above, one challenge in cloud TV UI arises when transitioning from embedded ABR video within a UI to full-screen playback and display of the ABR video, e.g., when the user, upon seeing the preview of the video associated with the highlighted tile, selects the media content item for viewing. In the native solution, this transition would require switching both the video and audio streams, potentially causing a noticeable interruption or synchronization issue. Using feedback mechanism described above, the video PTS values for an embedded video in UI video frames 410 are synchronized with the audio PTS values for the corresponding audio units 420 at time t₁, as indicated by the dashed line. When transitioning to a full screen ABR video 430 at time t₂, the audio units continue to be delivered uninterrupted on the same ABR stream, e.g., from the CDN 130 (FIG. 1), while only the video feed transitions from the UI video frames 410 delivered via WebRTC to a full screen ABR stream. This eliminates any potential disruption in audio playback during the switch, thus providing a smoother user experience. In some embodiments, the cloud sends the metadata (e.g., alongside the embedded video PTS), which includes packaged current playable URL or a play session identifier of the currently playing asset to signal the client device about a stream switch. Upon receiving and extracting the playable URL and/or the play session identifier, the client device requests and obtains the video packets from the CDN 130 (FIG. 1) along with requesting and obtaining the audio packets from the CDN 130 (FIG. 1), e.g., through a HTTP ABR stream.

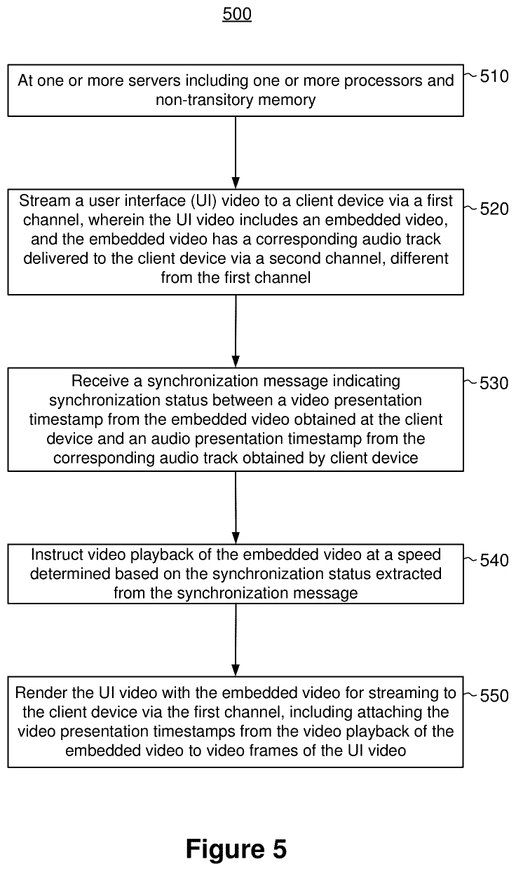

FIG. 5 is a flowchart illustrating a method 500 for video and audio synchronization in cloud-based UI streaming in accordance with some embodiments. In some embodiments, as represented by block 510, the method 500 is performed at one or more servers that include one or more processors and non-transitory memory, e.g., the one or more servers hosting the cloud computing platform 10 (FIG. 1). In some embodiments, one or more components of the server(s) are located in a core network, distributed between a core network and an edge device, or on an edge device. As represented by block 520, the method 500 includes streaming a user interface (UI) video to a client device via a first channel, wherein the UI video includes an embedded video, and the embedded video has a corresponding audio track delivered to the client device via a second channel, different from the first channel. For example, the exemplary UI frame 210 shown in FIG. 2 and the exemplary UI video frames 410 shown in FIG. 4 includes the embedded video 220. As shown in FIG. 1, the UI video frames, which include the embedded ABR video, are streamed from the cloud computing platform 110 to the client device 120 via a low latency channel, e.g., WebRTC and/or RTP, while the audio data for the corresponding audio tracks of the embedded ABR video are delivered to the client device 120 from the CDN via a different channel, e.g., HTTP.

As represented by block 530, the method 500 includes receiving a synchronization message indicating synchronization status between a video presentation timestamp from the embedded video obtained at the client device and an audio presentation timestamp from the corresponding audio track obtained by client device. For example, in FIG. 2, before the video decoder(s) and the audio decoder 129 decode the video and audio frames, the PTS reporter 124 obtains the video PTS and the audio PTS values and generates the synchronization message to indicate whether the video PTS and the audio PTS values are out of sync, e.g., significantly different from each other. Also as shown in FIG. 2, the PTS reporter 124 sends the synchronization message to the cloud upon the client device decoding the video frames of the UI video (e.g., by the video decoder(s) 126) including the embedded video frames and the audio track for the embedded video (e.g., by the audio encoder 129). In some embodiments, the synchronization messages include the video and audio PTS values so that the synchronization controller 20 can determine the synchronization status in the cloud based on the difference between the video and audio PTS values. In some other embodiments, the PTS reporter 124 determines whether the video and the audio streams are out of sync and reports to the synchronization controller 20 indicating the synchronization status, e.g., whether the values are out of sync and/or the difference between the values, etc.

As represented by block 540, the method 500 also includes instructing video playback of the embedded video at a speed determined based on the synchronization status extracted from the synchronization message. For example, in FIG. 2, the synchronization controller 20 sets rate for the ABR player 50, e.g., normal playout speed when rate=1, slow playout speed when rate=0.5, or fast playout speed when rate=1.5, etc. In another example, in FIG. 3, at time T₁, the synchronization controller 20 (FIGS. 1 and 2) instructs the ABR player 50 (FIGS. 1 and 2) to reduce the playback speed or rate of the embedded video based on the synchronization status indicating the audio PTS corresponding to the embedded video is behind the video PTS of the embedded video. Also in FIG. 3, at time T₂, the synchronization controller 20 (FIGS. 1 and 2) instructs the ABR player 50 (FIGS. 1 and 2) to increase the playback speed or rate of the embedded video based on the synchronization status indicating the audio PTS corresponding to the embedded video is ahead of the video PTS of the embedded video.

As represented by block 550, the method 500 additionally includes rendering the UI video with the embedded video for streaming to the client device via the first channel, including attaching the video presentation timestamps from the video playback of the embedded video to video frames of the UI video. For example, in FIG. 2, the rendering engine 30 renders the UI video frames 210 and attaches the video presentation timestamps from the video playback of the embedded video 220 by the ABR player 50 to the UI video frames 210. The cloud-rendered UI video frames are then encoded by the low latency encoder 40-1 and streamed to the client device via a low latency channel as shown in FIG. 1.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at one or more servers including one or more processors, non-transitory memory, and one or more transceivers:
streaming a user interface (UI) video to a client device via a first channel, wherein the UI video includes an embedded video, and the embedded video has a corresponding audio track delivered to the client device via a second channel, different from the first channel;
receiving a synchronization message indicating synchronization status between a video presentation timestamp from the embedded video obtained at the client device and an audio presentation timestamp from the corresponding audio track obtained by client device;
instructing video playback of the embedded video by the one or more servers at a speed determined based on the synchronization status extracted from the synchronization message; and
generating the UI video with the embedded video for streaming to the client device via the first channel, including rendering UI elements, compositing the rendered UI elements with the embedded video played by the one or more servers at the speed to generate video frames of the UI video, and attaching the video presentation timestamps from the video playback of the embedded video by the one or more servers to the video frames of the UI video.

2. The method of claim 1, wherein the synchronization message includes the video presentation timestamp and the audio presentation timestamp indicating the synchronization status at the client device.

3. The method of claim 1, wherein the synchronization message includes a difference between the video presentation timestamp and the audio presentation timestamp as the synchronization status.

4. The method of claim 3, wherein the synchronization message is transmitted by the client device upon the client device determining the difference between the video presentation timestamp and the audio presentation timestamp is greater than a threshold.

5. The method of claim 1, wherein the synchronization message is generated by the client device upon the client device decoding the video frames of the UI video and the audio track.

6. The method of claim 1, wherein instructing the video playback of the embedded video at the speed determined based on the synchronization status extracted from the synchronization message includes:
increasing or decreasing the speed of the video playback based on whether the synchronization status indicates the video presentation timestamp is behind or ahead of the audio presentation timestamp; and
choosing a respective frame of the embedded video to decode according to the speed.

7. The method of claim 1, further comprising:
setting the speed to a normal rate when the synchronization status indicates a difference between the video presentation timestamp and the audio presentation timestamp is below a threshold.

8. The method of claim 1, wherein the synchronization message is received over a low latency content delivery protocol.

9. The method of claim 1, further comprising:
signaling a stream switch to the client device, wherein the stream switch includes a playable URL corresponding to the embedded video; and
causing the client device to obtain the embedded video through the second channel for full screen display while maintaining the audio track delivery through the second channel.

10. The method of claim 9, wherein signaling the stream switch to the client device includes:
packaging the playable URL as metadata to be attached along with the video presentation timestamp to the video frames of the UI video.

11. A server comprising:
one or more processors;
non-transitory memory;
one or more transceivers; and
one or more programs, stored in the non-transitory memory, which, when executed by the one or more processors, cause the server to:
stream a user interface (UI) video to a client device via a first channel, wherein the UI video includes an embedded video, and the embedded video has a corresponding audio track delivered to the client device via a second channel, different from the first channel;
receive a synchronization message indicating synchronization status between a video presentation timestamp from the embedded video obtained at the client device and an audio presentation timestamp from the corresponding audio track obtained by client device;
instruct video playback of the embedded video by the server at a speed determined based on the synchronization status extracted from the synchronization message; and
generate the UI video with the embedded video for streaming to the client device via the first channel, including rendering UI elements, compositing the rendered UI elements with the embedded video played by the server at the speed to generate video frames of the UI video, and attaching the video presentation timestamps from the video playback of the embedded video by the server to the video frames of the UI video.

12. The server of claim 11, wherein the synchronization message includes the video presentation timestamp and the audio presentation timestamp indicating the synchronization status at the client device.

13. The server of claim 11, wherein the synchronization message includes a difference between the video presentation timestamp and the audio presentation timestamp as the synchronization status.

14. The server of claim 13, wherein the synchronization message is transmitted by the client device upon the client device determining the difference between the video presentation timestamp and the audio presentation timestamp is greater than a threshold.

15. The server of claim 11, wherein the synchronization message is generated by the client device upon the client device decoding the video frames of the UI video and the audio track.

16. The server of claim 11, wherein instructing the video playback of the embedded video at the speed determined based on the synchronization status extracted from the synchronization message includes:
increasing or decreasing the speed of the video playback based on whether the synchronization status indicates the video presentation timestamp is behind or ahead of the audio presentation timestamp; and
choosing a respective frame of the embedded video to decode according to the speed.

17. The server of claim 11, wherein the one or more programs, which, when executed by the one or more processors, cause the server to:
set the speed to a normal rate when the synchronization status indicates a difference between the video presentation timestamp and the audio presentation timestamp is below a threshold.

18. The server of claim 11, wherein the synchronization message is received over a low latency content delivery protocol.

19. The server of claim 11, wherein the one or more programs, which, when executed by the one or more processors, cause the server to:
signal a stream switch to the client device, wherein the stream switch includes a playable URL corresponding to the embedded video; and
cause the client device to obtain the embedded video through the second channel for full screen display while maintaining the audio track delivery through the second channel.

20. The server of claim 19, wherein signaling the stream switch to the client device includes:
packaging the playable URL as metadata to be attached along with the video presentation timestamp to the video frames of the UI video.
